(19) United States
(12) Patent Application Publication
(10) Pub. No.: US 2007/0241480 A1
(43) Pub. Date: Oct. 18, 2007

(54) Rubber/Short Fiber Master Batch and Production Method Thereof and Pneumatic Tires Using Such Master Batch

(75) Inventors: Daisuke Kanenari, Kanagawa (JP); Hidekazu Takeyama, Kanagawa (JP)

Correspondence Address: CONNOLLY BOVE LODGE & HUTZ LLP, 1875 EYE STREET, N.W., SUITE 1100, WASHINGTON, DC, 20036, US

(73) Assignee: The Yokohama Rubber Co., Ltd., Tokyo (JP)

(21) Appl. No.: 10/588,102

(22) PCT Filed: Dec. 20, 2005
(86) PCT No.: PCT/JP05/23833

§ 371 Date: Jul. 31, 2006

(30) Foreign Application Priority Data
Dec. 27, 2004 (JP) 2004-376983
May 26, 2005 (JP) 2005-154228

(51) Int. Cl. B60C 9/02

(52) U.S. Cl. 264/349; 106/38.6; 152/548

(57) ABSTRACT

A rubber/short fiber master batch obtained by stirring and mixing an aqueous dispersion of short fibers having an average diameter of less than 0.5 μm and a rubber latex, followed by removing the water from the mixture and a practical production method of the same and a pneumatic tire using the master batch.

### FIELD OF THE INVENTION

The present invention relates to a rubber/short fiber master batch and a method for producing the same and a pneumatic tire using the same. More particularly, it relates to a rubber/short fiber master batch composed of short fibers having an average diameter of less than 0.5 μm uniformly dispersed in rubber and a practical production method of the same and a pneumatic tire having an improved cut resistance and other physical properties using the master batch.

### BACKGROUND OF THE INVENTION

A technology reinforcing rubber by short fibers so as to improve the hardness or modulus, etc. is already known. Short fibers easily disperse in rubber, when thick in the diameter, but the fatigue resistance and other physical properties are decreased. Conversely, if made thinner, while the reinforcement and fatigue resistance are improved, there is the problem that the short fibers entangle and the dispersibility in rubber becomes poor. To solve these problems, it is proposed to disperse short fibers with islands-in-the-sea structures in fiber cross-sections into the rubber and use the shear force at the time of mixing to fibrillate the short fibers and thus achieve both dispersion and fatigue resistance (for example, see JP-A-10-7811). However, these short fibers have to be mixed with the rubber for a long time, and, therefore, there were the problems of deterioration of the matrix rubber and difficulty in control of the degree of fibrillation.

Further, for example, JP-A-56-100801 discloses a method for passing a suspension of fibrous cellulose through a small sized orifice at a high pressure to obtain microfibrillated cellulose, but this is obtained in the state of an aqueous dispersion, and, therefore, coagulation occurs upon drying. Thus, the practice has not been for drying and then blending it into the rubber. Note that JP-A-2001-164052 discloses utilization of an aramide short fiber master batch for tires, but the diameter of the aramide short fibers disclosed in this publication is 0.5 to 1000 μm. The short fibers are large in the diameter, and therefore, problems remain in the fatigue resistance.

On the other hand, various physical properties are required at the different portions of a pneumatic tire according to their functions. There is active development going on in rubber compositions suitable for tire beads (usually composed of bead wires, bead covers, bead fillers, gum finishings, rim cushions, etc.), in particular for gum finishings and rim cushions (for example, see JP-A-9-59430). Development is also underway for improving tire productivity, while maintaining the performance of such tire parts. For example, attempts are being made to form gum finishings, without compounding short fibers, but the cut resistance is not satisfactory. Further, run flat tires designed to enable the tire to be run on for a certain distance even if a puncture or bursting etc. causes the tire internal pressure to rapidly drop are known. In recent years, various means have been applied to achieve both run flat properties and reduced weight (for example, see JP-A-2004-1627). Therefore, attempts are being made to reduce the thickness of sidewalls of run flat tires of the side reinforcement type so as to reduce the weight of the tires, but the cut resistance is a problem.

### SUMMARY OF THE INVENTION

Accordingly, an object of the present invention is to provide a rubber/short fiber master batch composed of short fibers having an average diameter of less than 0.5 μm uniformly dispersed in rubber and a method for practically producing the same.

Another object of the present invention is to provide a rubber composition having a superior cut resistance etc. and suitable for use for a bead of a pneumatic tire, in particular gum finishings or rim cushions, and further a sidewall of a run flat tire etc. and a tire using the same.

In accordance with the present invention, there is provided a rubber/short fiber master batch obtainable by stirring and mixing an aqueous dispersion of short fibers having an average diameter of less than 0.5 μm and a rubber latex and removing the water from the mixture, preferably one wherein the compounding amount of said short fiber is 0.1 to 100 parts by weight per 100 parts by weight of the rubber, in terms of solid content (hereinafter referred to as “0.1 to 100 phr”).

In accordance with the present invention, there is also provided a method for producing a rubber/short fiber master batch comprising stirring and mixing an aqueous dispersion of short fibers having an average diameter of less than 0.5 μm and a rubber latex, then spraying the mixture for drying under an atmosphere of a shock wave generated from pulse combustion and a rubber/short fiber master batch obtained by the same.

In accordance with the present invention, there is further provided a pneumatic tire using such a rubber composition having a content of short fibers of 2 to 20 phr for a gum finishing or rim cushion.

In accordance with the present invention, there is further provided a pneumatic tire using such a rubber composition having a content of short fibers of 0.1 to 10 phr for the sidewalls.

### BEST MODE FOR CARRYING OUT THE INVENTION

In the present invention, an aqueous dispersion of short fibers having an average diameter of less than 0.5 μm, preferably 0.001 to 0.4 μm, and a rubber latex are stirred and mixed, then the water is removed from the mixture to produce a rubber/short fiber master batch. If mixing short fibers into rubber by a Banbury mixer, etc. like in the past, dispersion tends to become poor, but, like in the present invention, by fibrillating short fibers having an average diameter of less than 0.5 μm in advance in water to obtain a dispersion and mixing the dispersion with a rubber latex and drying the mixture, it is possible to cause the short fibers to uniformly disperse in the rubber. This rubber/short fiber master batch may be utilized to obtain a rubber composition having the balanced rubber reinforcement and fatigue resistance. This rubber composition is superior in the cut resistance and other physical properties, and therefore, is suitable for use for the bead of pneumatic tires, in particular gum finishings and rim cushions, and further for the sidewalls of run flat tires.

According to the present invention, by stirring and mixing an aqueous dispersion of short fibers having an average diameter of less than 0.5 μm, preferably 0.001 to 0.4 μm, and a rubber latex and removing the water from the mixture, it is possible to obtain a rubber/short fiber master batch composed of a rubber in which short fibers are uniformly dispersed. As the rubber latex used, for example, rubber latexes such as natural rubber (NR), polyisoprene rubber (IR), styrene-butadiene copolymer rubber (SBR), polybutadiene rubber (BR), butyl rubber (IIR), nitrile rubber (NBR), chloroprene rubber (CR), acrylic rubber (ACM), fluororubber (FKM), preferably having a concentration of 5 to 60% by weight, can be preferably used.

The short fibers usable in the present invention are not particularly limited in type so long as they are fibers fibrillated by mechanical shear force, but those selected from cellulose, aramide, polyvinyl alcohol (PVA), etc. alone or in any mixture thereof are preferably used. The compounded amount of the short fibers is preferably 0.1 to 100 parts by weight, more preferably 1 to 30 parts by weight, based upon 100 parts by weight of rubber, in terms of the solid content. To make such short fibers, it is possible to disperse short fibers in water, then beat short fibers or pass short fibers through orifices or otherwise apply mechanical shear force. In actuality, short fibers having various diameters are commercially available. In the present invention, these short fibers may be dispersed in water and fibrillated for use by, for example, a high pressure homogenizer etc.

The method of mixing the aqueous dispersion of rubber latex and short fibers according to the present invention is not particularly limited. For example, general methods such as a propeller type stirring machine, homogenizer, rotary stirring machine, electromagnetic stirring machine, manual stirring may be used. In the present invention, the water may be removed from the mixture of the rubber latex and aqueous short fiber dispersion by, for example, general methods such as natural drying, oven drying, freeze drying, spray drying. In a preferred embodiment of the present invention, the mixture is dried under a shock wave generated from pulse combustion so as to produce a master batch by a sufficient capability industrially, without applying shear force and so as to give a master batch, which is easy to handle. By using this master batch for a rubber composition, it becomes easy to achieve both reinforcement and fatigue resistance. That is, in a preferred embodiment of the present invention, a rubber latex/short fiber mixed dispersion is sprayed under an atmosphere of a shock wave generated from pulse combustion so as to remove the moisture and dry the mixture instantaneously.

The method for drying a mixture by spraying under an atmosphere of a shock wave generated from pulse combustion is known. For example, it is possible to use the pulse combustor generating a pulse shock wave described in JP-A-6-28681, etc. for drying to produce a rubber/short fiber master batch. In the present invention, it is possible to use such a pulse combustor to spray dry a mixture of preferably a solid concentration of not more than 60% by weight in a drying chamber under conditions of preferably a frequency of 50 to 1200 Hz, more preferably 250 to 1000 Hz, and preferably a temperature of not more than 140° C., more preferably 40 to 100° C., so as to obtain a rubber/short fiber master batch.

The solid concentration of the mixture of the rubber/short fiber dispersion to be dried according to the present invention is not particularly limited, but 60% by weight or less is preferable. 3 to 30% by weight is further preferable. If the solid concentration is more than 60% by weight, the viscosity of the mixture becomes too high, so when charging it into a pulse shock wave drier, it will solidify in the transport pipes and will not be sprayed well into the combustion chamber or other inconveniences are liable to arise. Further, if the solid concentration is too low, while the drying itself will not be a problem, the amount of the polymer mixture able to be dried in a unit time will fall, which is liable to become a problem in drying efficiency. The preferable viscosity of the mixture before drying is not more than 2000 mPa·s, more preferably not more than 1500 mPa·s, at 25° C.

According to the present invention, it is possible to compound said rubber/short fiber master batch into rubber to obtain a rubber composition. The rubber for compounding with the master batch is not particularly limited. Depending upon the object of use, rubber latexes such as natural rubber (NR), polyisoprene rubber (IR), polybutadiene rubber (BR), styrene-butadiene copolymer rubber (SBR), butyl rubber (IIR), nitrile rubber (NBR), chloroprene rubber (CR), acrylic rubber (ACM), fluororubber (FKM) can be mentioned. Further, resin latexes such as polystyrene, vinyl acetate, polyacrylate may be added in any ratio. The amounts of the master batch and rubber compounded also are not particularly limited, but preferably the content of the short fibers is made 0.1 to 30 parts by weight, more preferably 0.5 to 20 parts by weight, whereby the modulus of the rubber can be improved, without impairing the processability.

The rubber composition according to the present invention may contain fillers such as carbon black, silica, a vulcanization or cross-linking agent, a vulcanization or cross-linking accelerator, various types of oils, an antioxidant, a plasticizer, and other various types of additives generally compounded for tire or other general rubber uses. These additives may be mixed and vulcanized by a general method to obtain a composition for use for vulcanization or cross-linking. The compounding amounts of these additives may be made the general amounts used in the past in so far as the objects of the present invention are not contravened.

The rubber composition containing a rubber/short fiber master batch according to the present invention, as explained above, is suitable for use as a rubber composition for the tire bead of a pneumatic tire, in particular the rim cushion or gum finishing (or chaffer). This rubber composition can be used for producing a pneumatic tire by the same method as a conventional rubber composition. In particular, according to the method of the present invention, since short fibers can be obtained in a state uniformly dispersed in rubber of a latex state in advance, compared with dispersion in the solid state in rubber like in the past, the dispersibility is excellent and, in particular, the productivity in tire production can be greatly improved.

The bead of a pneumatic tire is provided with rubber containing reinforcing short fibers called “gum finishing (or chaffer)” to protect the tire at the time of rim assembly. There are also examples of use of gum finishing aiming at improving productivity and not containing fibers, but the cut resistance is not satisfactory. Technology for compounding short fibers into tire compounds is known, but the reinforcement and fatigue resistance are opposing properties. There is the problem that small average diameter short fibers give superior fatigue resistance, but are poor in dispersion.

The rubber composition containing a rubber/short fiber master batch according to the present invention can be compounded to give a content in the rubber composition of 2 to 20 phr, preferably 3 to 15 phr, and can be suitably used for the rim cushions and/or finishings of tires. If the amount of the short fibers is small, the effect of improvement of the cut resistance becomes small, and therefore this is not preferred, while conversely if too large, the processability of the rubber is decreased, which is also not preferred.

If short fibers are compounded into a side compound, the cut resistance is improved, but the repeated fatigue resistance is decreased. By using short fibers which unravel to small average diameter in water, it is possible to obtain a satisfactory balance of both the cut resistance and fatigue resistance. However, if small average diameter short fibers are dry mixed into rubber, the dispersion is poor and the fatigue resistance cannot be improved, but by mixing a rubber latex and an aqueous dispersion of short fibers and then removing the water, as in the present invention, a master batch having a good dispersibility is obtained. If the above-mentioned pulse combustion drying is used, as the method for removing the water, a compound having an industrially sufficient productivity is obtained.

The rubber composition containing a rubber/short fiber master batch according to the present invention further, as explained above, is suitable for use for reduction of weight of sidewalls of side reinforcement type run flat tires, that is, with the thickness of the sidewall rubber at a ½ portion of the height in the tire cross-section of a run flat tire being 1 to 4 mm. This rubber composition can be used for production of a run flat tire by a method similar to a conventional rubber composition.

Various studies have been made on technology for lightening the weight of run flat tires of the side reinforcement type, but if run flat sidewalls are made thinner, rubbing cuts due to the curbs which cannot be gripped will become a problem. If short fibers are compounded into the side compound, the cut resistance is improved, but the problem arises that the repeated fatigue resistance becomes inferior. As opposed to this, by mixing small average diameter short fibers unraveled in water with a latex and removing the water to obtain a rubber/short fiber master batch for use for a sidewall rubber composition, this problem can be solved. As the short fibers, in particular an aramide is suitably used.

The rubber composition containing the rubber/short fiber master batch according to the present invention may be compounded to give a content of short fibers in the rubber composition of 0.1 to 10 phr, preferably 0.5 to 8 phr, and suitably used for the sidewalls of a run flat tire. If the compounding amount is too small, the cut resistance is not improved, and, therefore, this is not preferred, while conversely if too large, the processability of the rubber deteriorates, and therefore this is not preferred.

As explained above, if short fibers are compounded into a side compound, the cut resistance is improved, but the repeated fatigue strength is inferior. Therefore, by using short fibers having small average diameters unraveled in water, a balance of the cut resistance and fatigue resistance can be satisfied. In this case, if short fibers having a small average diameter is dry mixed into the rubber, the dispersibility will be poor and the fatigue resistance cannot be improved, but according to the present invention, a master batch having a good dispersibility can be obtained by mixing the latex and aqueous dispersed short fibers and then removing the water. If using pulse combustion drying as the method for removing the water, a compound can be obtained with a industrially sufficient productivity.

Further, when a rubber composition containing a rubber/short fiber master batch according to the present invention is used for a belt edge of a tire, as in JP-A-11-99806, a reduction in the road noise of the tire can be expected.

### EXAMPLES

Examples will now be used to further explain the present invention, but the scope of the present invention is by no means limited to these Examples.

### Examples 1 to 3 and Comparative Examples 1 to 4

### Production of Master Batches (MB) #A to #E

According to the formulations shown in Table I, various types of fibers were processed by homogenizers to obtain short fibers which were then charged into 50 times that amount of water, then predetermined amounts of NR latex were added and the resultant mixtures gently stirred for mixing and dispersion. Each formulation was then dried by an oven or pulse combustion as shown in Table I as follows.

Oven drying: The mixture of rubber latex and short fibers dispersed in water was placed in a metal vat and left standing in a 100° C. oven until the moisture completely evaporated.

Pulse combustion: The latex/short fiber mixture prepared in the same way as above (i.e., viscosity at 25° C.: 1700 mP·s) was dried by a Hypulcon made by Pultech (i.e., processing capacity of 2 kg/h), (pulse frequency 1000 Hz, drying chamber temperature 60° C.).

TABLE I

| | M.B. #A | M.B. #B | M.B. #C | M.B. #D | M.B. #E |
|---|---|---|---|---|---|
| Formulation (parts by weight) | | | | | |
| NR latex (HYTEX HA, Golden Hope Plantations) (solid content 60%) | 166.7 | 166.7 | 166.7 | 166.7 | 166.7 |
| Pulp (kraft pulp eucalyptus, CENIBRA) | 10 | — | — | — | — |
| Aramide short fiber (Kevlar cut fibers, Toray-Dupont) | — | 10 | — | — | — |
| Microfibrillated cellulose (Celish KY-100S, Daicel Chemical | — | — | 10 | — | 10 |
| Industries) | | | | | |
| Microfibrillated aramide (Tiara KY-400S, Daicel Chemical | — | — | — | 10 | — |
| Industries) | | | | | |
| Water | 500 | 500 | 500 | 500 | 500 |
| Average fiber diameter (μm) | 50 | 10 | 0.1 | 0.1 | 0.1 |
| Drying method | Oven | Oven | Oven | Oven | Pulse |
| | | | | | combustion |
| Preparation time (h) | 12 | 12 | 12 | 12 | 2 |

Preparation of Samples

In each of the formulations shown in Table II, the ingredients other than the vulcanization accelerator and sulfur were mixed in a 1.7 liter capacity Banbury mixer for 5 minutes and discharged when reaching 140° C. to obtain a master batch. The vulcanization accelerator and sulfur were mixed in the master batch by an 8-inch open roll to obtain a rubber composition.

Next, the rubber composition thus obtained was vulcanized in a 15×15×0.2 cm mold at 150° C. for 30 minutes to prepare a vulcanized rubber sheet which was then tested for the physical properties of the vulcanized rubber according to the following test methods. The results are shown in Table II.

Physical Property Evaluation Test Methods

Dispersibility of Short Fiber

Each vulcanized rubber composition obtained was cut and the state of dispersion of the short fibers was visually judged by the following criteria from a photograph enlarged by an optical microscope (×300):

A: No poor dispersion able to seen by naked eye

B: Slight regions of poor dispersion observed

C: Poor dispersion of fibers seen in rubber sheet as a whole

Tensile Test

50% modulus: Measured according to JIS K6251 (JIS No. 3 dumbbell)

Tensile strength at break: Measured according to JIS K6251 (JIS No. 3 dumbbell)

Elongation at break: Measured according to JIS K6251 (JIS No. 3 dumbbell)

Constant Strain Sheet Fatigue Test

A sample punched out into a JIS No. 3 dumbbell shape was repeatedly given strain at a strain rate of 20% and 400 rpm. The number of times until breakage was measured. The average value of n=5 was shown in Table II.

TABLE II

| | Comp. | Comp. | Comp. | Comp. | | | |
|---|---|---|---|---|---|---|---|
| | Ex. 1 | Ex. 2 | Ex. 3 | Ex. 4 | Ex. 1 | Ex. 2 | Ex. 3 |
| Formulation (parts by weight) | | | | | | | |
| NR (RSS#3) | 100 | 100 | 100 | 100 | 100 | 100 | 100 |
| Aramide short fiber (Kevlar cut fiber, Toray Dupont) | 5 | — | — | — | — | — | — |
| Microfibrillated cellulose (Celish KY-100S, Daicel Chemical | — | — | — | 5 | — | — | — |
| Industries) | | | | | | | |
| M.B. #A (see Table I) | — | 55 | — | — | — | — | — |
| M.B. #B (see Table I) | — | — | 55 | — | — | — | — |
| M.B. #C (see Table I) | — | — | — | — | 55 | — | — |
| M.B. #D (see Table I) | — | — | — | — | — | 55 | — |
| M.B. #E (see Table I) | — | — | — | — | — | — | 55 |
| HAF grade carbon (SHOBLACK N339, Showa-Cabot) | 40 | 40 | 40 | 40 | 40 | 40 | 40 |
| Zinc oxide (Zinc White #3, Seido Chemical) | 5 | 5 | 5 | 5 | 5 | 5 | 5 |
| Stearic acid (Beads Stearic Acid, NOF Corporation) | 2 | 2 | 2 | 2 | 2 | 2 | 2 |
| Aromatic oil (Extract #4S, Showa Shell Oil) | 5 | 5 | 5 | 5 | 5 | 5 | 5 |
| Sulfur (Gold Flower brand sulfur powder, 150 mesh, Tsurumi | 2 | 2 | 2 | 2 | 2 | 2 | 2 |
| Chemical Industry) | | | | | | | |
| Vulcanization accelerator (Noccelar NS-F), Ouchi Shinko | 1 | 1 | 1 | 1 | 1 | 1 | 1 |
| Chemical Industries) | | | | | | | |
| Short fiber dispersion | | | | | | | |
| (visual judgment) | C | B | B | C | A | A | A |
| Physical properties of material (room temperature) | | | | | | | |
| 50% modulus (MPa) | 7.8 | 4.3 | 7.6 | 5.6 | 6.6 | 7.7 | 6.8 |
| Tensile strength at break (MPa) | 18.2 | 22.6 | 25.0 | 16.1 | 24.8 | 27.2 | 26.8 |
| Elongation at break (%) | 220 | 370 | 340 | 190 | 390 | 420 | 420 |
| Constant strain sheet fatigue test (times until breakage) | 25 | 32 | 40 | 19 | 180 | 150 | 210 |
| (×10,000) | | | | | | | |

### Examples 4 to 6 and Comparative Examples 5 to 7

### Production of Master Batches (MB) #F to #H

According to the formulations shown in Table III (parts by weight), various types of fibers were processed by homogenizers to obtain short fibers which were then charged into 50 times that amount of water, then predetermined amounts of NR latex were added and the results gently stirred. The latex/short fiber mixtures thus obtained were dried by a Hypulcon made by Pultech (i.e., processing capacity of 2 kg/h, pulse frequency 1000 Hz, drying chamber temperature 70° C.).

TABLE III

| Name of ingredient | M.B. #F | M.B. #G | M.B. #H |
|---|---|---|---|
| NR latex (HYTEX HA, Golden | 166.7 | 166.7 | 166.7 |
| Hope Plantations) | | | |
| Pulp (kraft pulp (eucalyptus), | 20 | — | — |
| CENIBRA) | | | |
| Microfibrillated cellulose | — | 20 | — |
| (Celish KY-100S, Daicel | | | |
| Chemical Industries) | | | |
| Microfibrillated aramide | — | — | 20 |
| (Tiara KY-400S, Daicel | | | |
| Chemical Industries) | | | |
| Water | 500 | 500 | 500 |
| Average fiber diameter (μm) | 50 | 10 | 0.1 |

Preparation of Samples

In each of the formulations shown in Table IV (parts by weight), the ingredients other than the vulcanization accelerator and sulfur were mixed in a 1.7 liter capacity Banbury mixer for 5 minutes and discharged when reaching 140° C. to obtain a master batch. The vulcanization accelerator and sulfur were mixed in the master batch by an 8-inch open roll to obtain a rubber composition.

Next, the rubber composition thus obtained was vulcanized in a 15×15×0.2 cm mold at 170° C. for 10 minutes to prepare a vulcanized rubber sheet or guillotine cut test sample which was then tested for the physical properties of the vulcanized rubber by the following test method. The results are shown in Table IV.

TABLE IV

| | Comp. | Comp. | Comp. | | | |
|---|---|---|---|---|---|---|
| | Ex. 5 | Ex. 6 | Ex. 7 | Ex. 4 | Ex. 5 | Ex. 6 |
| Name of ingredient | | | | | | |
| NR (STR20) | 60 | 60 | 30 | 30 | 10 | 30 |
| BR (Nipol BR1220, Nippon Zeon) | 40 | 40 | 40 | 40 | 40 | 40 |
| Aramide short fiber (Kevlar cut fiber, Toray Dupont) | — | 5 | — | — | — | — |
| M.B. #F | — | — | 35 | — | — | — |
| M.B. #G | — | — | — | 35 | 60 | — |
| M.B. #H | — | — | — | — | — | 35 |
| HAF grade carbon (Seast N, Tokai Carbon) | 70 | 70 | 70 | 70 | 70 | 70 |
| Zinc oxide (Zinc White #3, Seido Chemical) | 3 | 3 | 3 | 3 | 3 | 3 |
| Stearic acid (Beads Stearic Acid, NOF Corporation) | 2 | 2 | 2 | 2 | 2 | 2 |
| Antioxidant (Nocrac 6C, Ouchi Shinko Chemical Industries) | 2 | 2 | 2 | 2 | 2 | 2 |
| Wax (Sannox, Ouchi Shinko Chemical Industries) | 1 | 1 | 1 | 1 | 1 | 1 |
| Aromatic oil (Extract #4S, Showa Shell Oil) | 10 | 10 | 10 | 10 | 10 | 10 |
| Sulfur (Crystex HS OT 20, Akzo Nobel) | 3 | 3 | 3 | 3 | 3 | 3 |
| Vulcanization accelerator (Noccelar NS-F), Ouchi Shinko Chemical | 1 | 1 | 1 | 1 | 1 | 1 |
| Industries) | | | | | | |
| Short fiber dispersion | | | | | | |
| (Visual judgment) | — | B | B | A | A | A |
| Tensile test (room temperature) | | | | | | |
| 50% modulus (MPa) | 2.0 | 11.1 | 8.6 | 10.5 | 14.8 | 10.9 |
| Tensile strength at break (MPa) | 19.0 | 16.5 | 17.1 | 17.9 | 16.0 | 17.2 |
| Elongation at break (%) | 280 | 210 | 250 | 270 | 220 | 240 |
| Guillotine cut test | | | | | | |
| Cut amount (mm) | 16 | 8 | 11 | 9 | 5 | 7 |
| Rim assembly test | | | | | | |
| Judgment | P | F | F | G | G | G |

Physical Property Evaluation Test Methods

Dispersibility of Short Fiber

Each vulcanized rubber composition obtained was cut and the state of dispersion of the short fibers was visually judged by the following criteria from a photograph enlarged by an optical microscope (X300):

A: No poor dispersion able to seen by naked eye

B: Slight regions of poor dispersion observed

C: Poor dispersion of fibers seen in rubber sheet as a whole

Tensile Test

According to JIS K6251, a tensile test was conducted for measurement by a JIS No. 3 dumbbell shape.

Guillotine Cut Test

A 50 mm (length)×100 mm (width)×20 mm (height) sample of vulcanized rubber was prepared and measured for depth of cut (mm) caused by naturally dropping a sharp knife of a weight of 3.0 kg on it from 25 cm above the sample.

Rim Assembly Test

Tires (195/55R15) were made using the formulations of the Comparative Examples and the Examples. These were mounted on and dismounted from rims repeatedly 10 times, then the damages to the beads were visually examined (no damage indicated by “G”, damage was indicated by “P”, and a state inbetween the two was indicated by “F”).

### Examples 7 to 9 and Comparative Examples 8 to 10

### Production of Master Batches (MB) #I to #K

According to the formulations shown in Table V (parts by weight), various types of fibers were processed by homogenizers to obtain short fibers which were then charged into 50 times that amount of water, then predetermined amounts of NR latex were added and the resultant mixtures gently stirred. The latex/short fiber mixtures obtained were dried by a Hypulcon made by Pultech (processing capacity of 2 kg/h, pulse frequency 1000 Hz, drying chamber temperature 60° C.).

TABLE V

| Name of ingredient | M.B. #I | M.B. #J | M.B. #K |
|---|---|---|---|
| NR latex (HYTEX HA, Golden | 166.7 | 166.7 | 166.7 |
| Hope Plantations) | | | |
| Pulp (kraft pulp (eucalyptus), | 10 | — | — |
| CENIBRA) | | | |
| Microfibrillated cellulose | — | 10 | — |
| (Celish KY-100S, Daicel | | | |
| Chemical Industries) | | | |
| Microfibrillated aramide | — | — | 10 |
| (Tiara KY-400S, Daicel | | | |
| Chemical Industries) | | | |
| Water | 500 | 500 | 500 |
| Average fiber diameter (μm) | 50 | 0.1 | 0.1 |

Preparation of Samples

In each of the formulations shown in Table VI (parts by weight), the ingredients other than the vulcanization accelerator and sulfur were mixed in a 1.7 liter capacity Banbury mixer for 5 minutes and discharged when reaching 140° C. to obtain a master batch. The vulcanization accelerator and sulfur were mixed in the master batch by an 8-inch open roll to obtain a rubber composition.

Next, the rubber composition, thus obtained was vulcanized in a 15×15×0.2 cm mold at 160° C. for 15 minutes to prepare a vulcanized rubber sheet which was then tested for the physical properties of the vulcanized rubber by the following test method. The results are shown in Table VI.

Physical Property Evaluation Test Methods

Short fiber dispersability: As explained above

Tensile test: As explained above

Ozone Resistance Test

According to JIS K6259, the sample was exposed for 72 hours to a temperature of 50° C. and an ozone concentration of 1 ppm (=100 pphm) at an elongation rate of 40%, then the surface of the sample was visually examined for the state of occurrence of cracks.

G (good): No occurrence of cracks observed

P (poor): Cracks occurred at surface

Pico Abrasion Test

According to ASTM D2228, a Pico abrasion tester was used for a test. The abrasion resistance was indicated indexed to Comparative Example 1 as 100. The larger the figure, the better the abrasion resistance shown.

TABLE VI

| | Comp. | Comp. | Comp. | | | |
|---|---|---|---|---|---|---|
| | Ex. 8 | Ex. 9 | Ex. 10 | Ex. 7 | Ex. 8 | Ex. 9 |
| Name of ingredient | | | | | | |
| NR (STR20) | 50 | 50 | — | — | 30 | — |
| BR (Nipol BR1220, Nippon Zeon) | 50 | 50 | 50 | 50 | 50 | 50 |
| Aramide short fiber (Kevlar cut fiber, Toray Dupont) | — | 5 | — | — | — | — |
| M.B. #I | — | — | 55 | — | — | — |
| M.B. #J | — | — | — | 55 | — | — |
| M.B. #K | — | — | — | — | 22 | 55 |
| FEF grade carbon (Diablack E, Mitsubishi Chemical) | 50 | 50 | 50 | 50 | 50 | 50 |
| Zinc oxide (Zinc White #3, Seido Chemical) | 3 | 3 | 3 | 3 | 3 | 3 |
| Stearic acid (Beads Stearic Acid, NOF Corporation) | 2 | 2 | 2 | 2 | 2 | 2 |
| Antioxidant (Nocrac 6C, Ouchi Shinko Chemical Industries) | 3 | 3 | 3 | 3 | 3 | 3 |
| Wax (Sannox, Ouchi Shinko Chemical Industries) | 1 | 1 | 1 | 1 | 1 | 1 |
| Aromatic oil (Extract #4S, Showa Shell Oil) | 10 | 10 | 10 | 10 | 10 | 10 |
| Sulfur (Gold Flower brand sulfur powder, Tsurumi Chemical) | 1.5 | 1.5 | 1.5 | 1.5 | 1.5 | 1.5 |
| Vulcanization accelerator (Noccelar NS-F), Ouchi Shinko Chemical | 1 | 1 | 1 | 1 | 1 | 1 |
| Industries) | | | | | | |
| Short fiber dispersion | | | | | | |
| (Visual judgment) | — | B | B | A | A | A |
| Tensile test (room temperature) | | | | | | |
| 50% modulus (MPa) | 0.9 | 7.2 | 4.8 | 6.9 | 3.2 | 7.1 |
| Tensile strength at break (MPa) | 17.1 | 13.6 | 15.0 | 15.8 | 16.9 | 15.5 |
| Elongation at break (%) | 550 | 260 | 460 | 450 | 510 | 440 |
| Ozone resistance test | | | | | | |
| Judgment | G | P | P | G | G | G |
| Pico abrasion test | | | | | | |
| Abrasion resistance (index) | 100 | 105 | 90 | 116 | 108 | 123 |

### Reference Example, Examples 10 to 12, and Comparative Example 11

Run flat tires having a tire size 225/45ZR17 were fabricated by the specifications shown in Table VII and tested for performance by the following methods. The results are shown in Table VII.

Curb Hitting Test

A test tire set to a pneumatic pressure of 140 kPa was mounted on the right front wheel of a 2 liters displacement passenger car and ridden up over a 5 cm height iron curb at an angle of 30 degrees. The limit speed when the carcass broke was shown. The test was started from a speed of 10 km/h and increased in increments of 2 km/h.

TABLE VII

| | Refer- | | | | |
|---|---|---|---|---|---|
| | ence | | | | |
| | Exam- | Comp. | | | |
| | ple | Ex. 11 | Ex. 10 | Ex. 11 | Ex. 12 |
| Structure | | | | | |
| Side rubber formulation | Comp. | Comp. | Ex. 7 | Ex. 9 | Ex. 9 |
| | Ex. 8 | Ex. 8 | | | |
| Sidewall thickness (mm) | 5 | 2 | 5 | 3 | 1 |
| Side reinforcing rubber | 8 | 8 | 8 | 8 | 8 |
| layer thickness (mm) | | | | | |
| Curb hitting test | | | | | |
| Limit speed (km/h) | 14 | 10 | 20 | 18 | 14 |

### INDUSTRIAL APPLICABILITY

According to the present invention, by dispersing short fiber having an average diameter of less than 0.5 μm in advance in water in a fibrillated state, stirring and mixing this with a rubber latex, and removing the water, it is possible to obtain a rubber/short fiber master batch, in which short fibers are uniformly dispersed. Further, by spray drying the dispersion to remove water under an atmosphere of a shock wave generated from pulse combustion, it is possible to produce the rubber/short fiber master batch by a method free from industrial obstacles. Therefore, this is useful as a master batch for rubber products such as tires, hoses, belts, rubber rollers, packing, gaskets, rubber vibration absorbers, weather strips, bushes, and printer rollers. In particular, this is superior in resistance to cuts, abrasion resistance, high hardness, etc., and therefore, is optimal for use for gum finishing and rim cushions of pneumatic tires and reinforcing sidewalls of run flat tires.

1. A rubber/short fiber master batch obtainable by stirring and mixing an aqueous dispersion of short fibers having an average diameter of less than 0.5 μm and a rubber latex, followed by removing the water from the mixture.

2. A rubber/short fiber master batch as claimed in claim 1, wherein the amount of said short fibers compounded is 0.1 to 100 parts by weight per 100 parts by weight of the rubber, in terms of solid content.

3. A rubber/short fiber master batch as claimed in claim 1, wherein said short fibers are at least one short fibers selected from the group consisting of cellulose, aramide and polyvinyl alcohol.

4. A method for producing a rubber/short fiber master batch comprising stirring and mixing an aqueous dispersion of short fibers having an average diameter of less than 0.5 μm and a rubber latex, then spraying the mixture for drying under an atmosphere of a shock wave generated from by pulse combustion.

5. A method for producing a rubber/short fiber master batch as claimed in claim 4, wherein a viscosity of said mixture at 25° C. before drying is not more than 2000 mP·s.

6. A method for producing a rubber/short fiber master batch as claimed in claim 4, wherein a frequency of the pulse combustion is 50 to 1200 Hz and a temperature of a drying chamber for spraying the mixture is not more than 140° C.

7. A rubber composition comprising a rubber/short fiber master batch as claimed in claim 1.

8. A rubber composition comprising a rubber/short fiber master batch obtainable by a method according to claim 4.

9. A pneumatic tire using a rubber composition according to claim 7 having a content of short fibers of 2 to 20 parts by weight per 100 parts by weight of the rubber, in terms of solid content, for a gum finishing or rim cushion.

10. A pneumatic tire as claimed in claim 9, wherein said rubber composition is arranged at a thickness of 0.5 to 3 mm at least at a bead portion of the pneumatic tire where said bead portion contacts the tire rim.

11. A pneumatic tire using a rubber composition according to claim 7 having a content of short fibers of 0.1 to 10 parts by weight per 100 parts by weight of the rubber, in terms of solid content, for the sidewalls.

12. A pneumatic tire as claimed in claim 11, wherein said pneumatic tire is a run flat tire.

13. A pneumatic tire as claimed in claim 12, wherein a thickness of a sidewall rubber at a portion of the run flat tire at ½ portion of the cross-sectional height of the tire is 1 to 4 mm.

14. A rubber/short fiber master batch as claimed in claim 2, wherein said short fibers are at least one short fibers selected from the group consisting of cellulose, aramide and polyvinyl alcohol.

15. A method for producing a rubber/short fiber master batch as claimed in claim 5, wherein a frequency of the pulse combustion is 50 to 1200 Hz and a temperature of a drying chamber for spraying the mixture is not more than 140° C.

16. A rubber composition comprising a rubber/short fiber master batch as claimed in claim 2.

17. A rubber composition comprising a rubber/short fiber master batch as claimed in claim 3.

18. A rubber composition comprising a rubber/short fiber master batch obtainable by a method according to claim 5.

19. A rubber composition comprising a rubber/short fiber master batch obtainable by a method according to claim 6.

20. A pneumatic tire using a rubber composition according to claim 8 having a content of short fibers of 2 to 20 parts by weight per 100 parts by weight of the rubber, in terms of solid content, for a gum finishing or rim cushion.
